(19) United States
(12) Patent Application Publication
(10) Pub. No.: US 2008/0040963 A1
(43) Pub. Date: Feb. 21, 2008

(54) Clip for displaying indicia

(76) Inventors: Steven Ochs, Nashville, TN (US); Kenneth Davidov, Ossining, NY (US)

Correspondence Address: GOTTLIEB RACKMAN & REISMAN PC, 270 MADISON AVENUE, 8TH FLOOR, NEW YORK, NY, 10016-0601, US

(21) Appl. No.: 11/725,318

(22) Filed: Mar. 19, 2007

Related U.S. Application Data
(60) Provisional application No. 60/784,530, filed on Mar. 21, 2006.

(51) Int. Cl. G09F 3/20

(52) U.S. Cl. 40/658; 24/3.12

(57) ABSTRACT

A clipping display device for use on hats, comprising a base and a clip for suspending the device along the brim of a hat. The device further comprises a top or billboard element attached to the base for displaying advertisement, logos, messages and other visual indicia. A neck element may be provided to connect the billboard element to said base. A front panel provided at a front end of the base balances the device and may also incorporate visual indicia. The device may optionally include interlocking elements for stringing multiple clips for forming a larger or more extensive message.

This application claims the priority date of U.S. provisional patent application Ser. No. 60/784,530 filed on Mar. 21, 2006, which is incorporated herein by reference.

### FIELD OF INVENTION

The present invention relates to a visual display for use on consumer products. More specifically, the invention relates to a hat clip that displays visual indicia.

### SUMMARY OF THE INVENTION

A primary object of the present invention is to provide a portable clip for displaying indicia.

It is a further objection of the present invention to provide a hat clip that comprises a miniature billboard for displaying advertisement, logos, messages and other visual indicia.

Additional objectives will be apparent from the description of the invention that follows.

In its broadest aspects, the invention comprises a base and a clip attached to the base for clipping the device to hats, clothing, bags and/or other objects. When utilized as a hat clip, depicted as a preferred embodiment of the present invention, the device is typically attached to the brim or bill of a hat, i.e. a baseball hat, visor or any other suitable hat with a cap or a brim. The device further comprises a neck for connecting the base to a generally upward/vertically oriented top or billboard that carries the payload advertising, and a front panel attached to the base. Multiple hat clips, for example, for displaying indicia may also be attached to a hat to create a longer or more extensive message. The device may optionally comprise interlocking elements at the sides of the billboard and/or the base for this purpose. The front panel balances the weight and allows the device to stand on its own, which is desirable for placing the device on a surface such as a desk in an upright position. Furthermore, the front panel can be permanently emblazoned with the same type of indicia as the billboard of the device. Thus, the device has multiple possible uses in creative mobile advertising, including applications such as promotional giveaways. Likewise, the device may also be worn by restaurant clerks, delivery couriers and other commercial entities to advertise new products and/or services.

### BRIEF DESCRIPTION OF THE DRAWINGS

With reference to the figures,

FIG. 1 is a perspective view of a preferred embodiment of the hat clip for displaying indicia of the present application;

FIG. 2 is a front view of the hat clip of FIG. 1;

FIG. 3 is a rear (back) view of the hat clip of FIG. 1;

FIG. 4 is a top view of the hat clip of FIG. 1;

FIG. 5 is a bottom view of the hat clip of FIG. 1;

FIG. 6 is a side view of the hat clip of FIG. 1;

FIG. 7 is a cross-sectional view taken along line A-A of the hat clip of FIG. 4;

FIG. 8 is a perspective view of the billboard of the hat clip of the present application;

FIG. 9 is a front view of the billboard of FIG. 8;

FIG. 10 is a top view of the billboard of FIG. 8;

FIG. 11 is a bottom view of the billboard of FIG. 8;

FIG. 12 is a rear (back) view of the billboard of FIG. 8;

FIG. 13 is a side view of the billboard of FIG. 8;

FIG. 14 is a cross-sectional view taken along line A-A of the billboard of FIG. 9;

FIG. 15 is a perspective view of the hat clip showing the use of the hat clip on a hat;

FIG. 16 is a front view of the hat clip showing the use of the hat clip on a hat;

FIG. 17 is a rear (back) view of the hat clip showing the use of the hat clip on a hat;

FIG. 18 is a top view of the hat clip showing the use of the hat clip on a hat;

FIG. 19 is a bottom view of the hat clip showing the use of the hat clip on a hat;

FIG. 20 is a side view of the hat clip showing the use of the hat clip on a hat;

FIG. 21 is a cross-sectional view taken along line A-A of FIG. 18 of the hat clip in use on a hat;

FIG. 22 is a perspective view of an alternative embodiment of the hat clip with a rotatable billboard; and

FIG. 23 is a perspective view of one possible attachment of the billboard to the base.

### DETAILED DESCRIPTION OF THE INVENTION

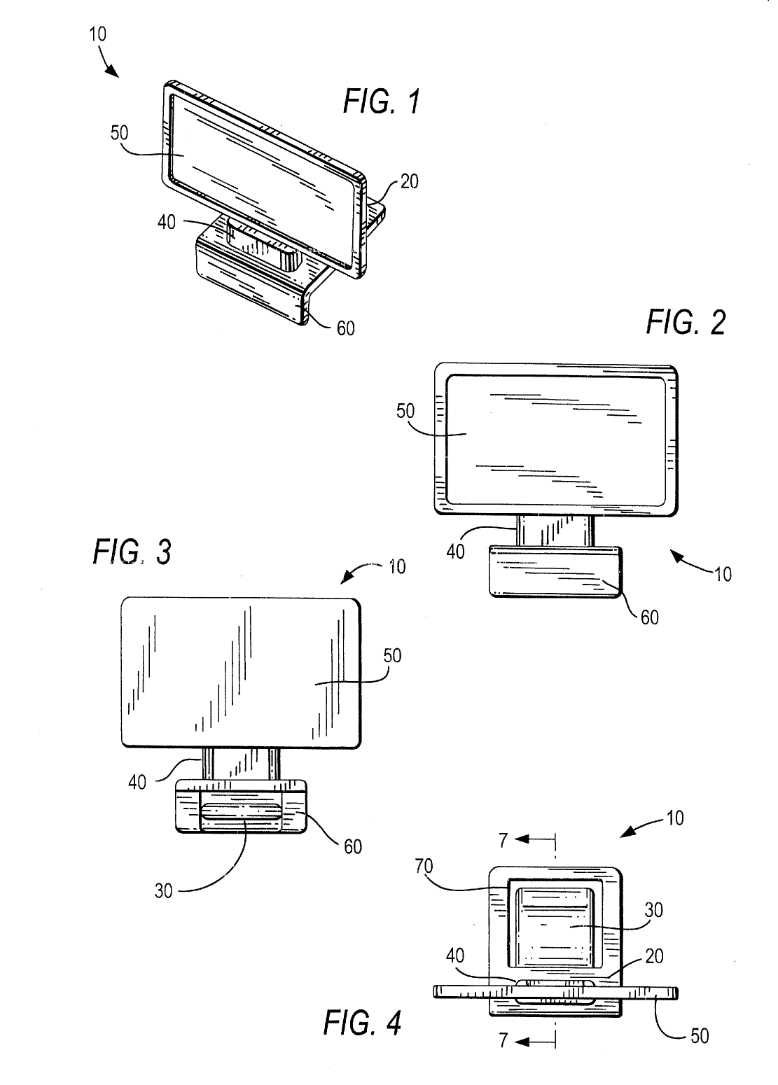

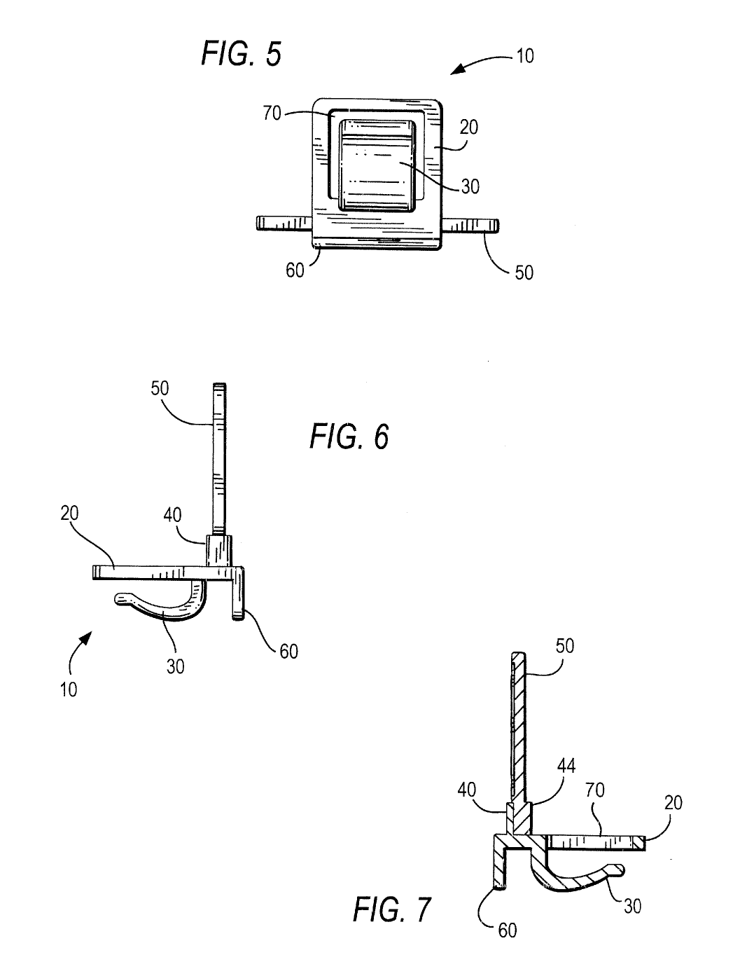

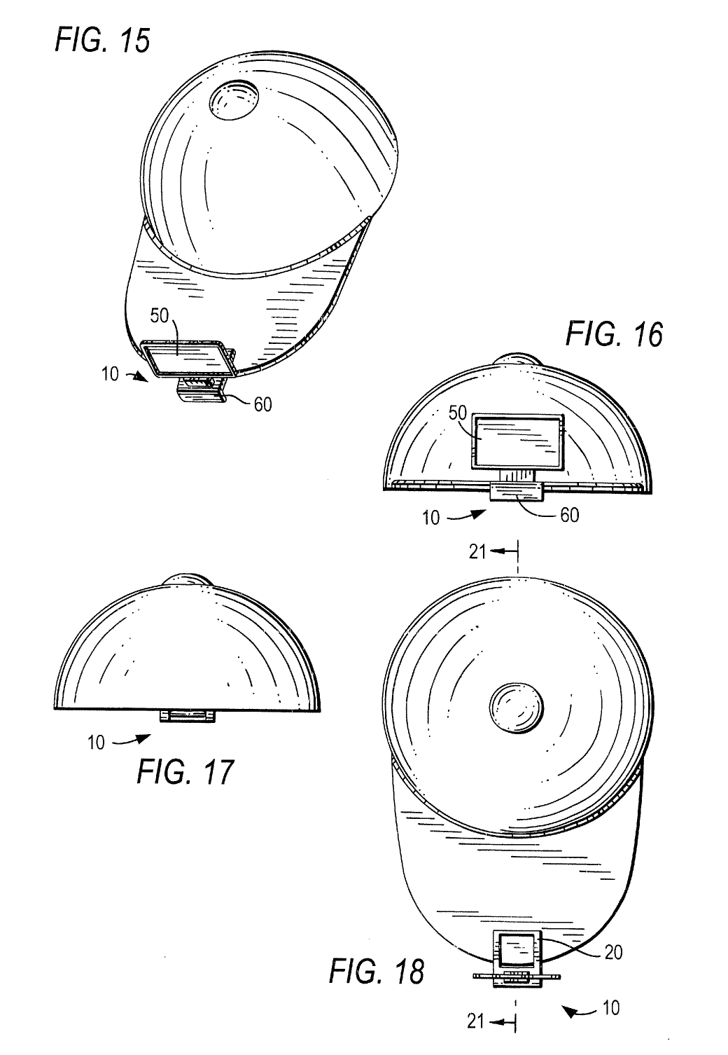

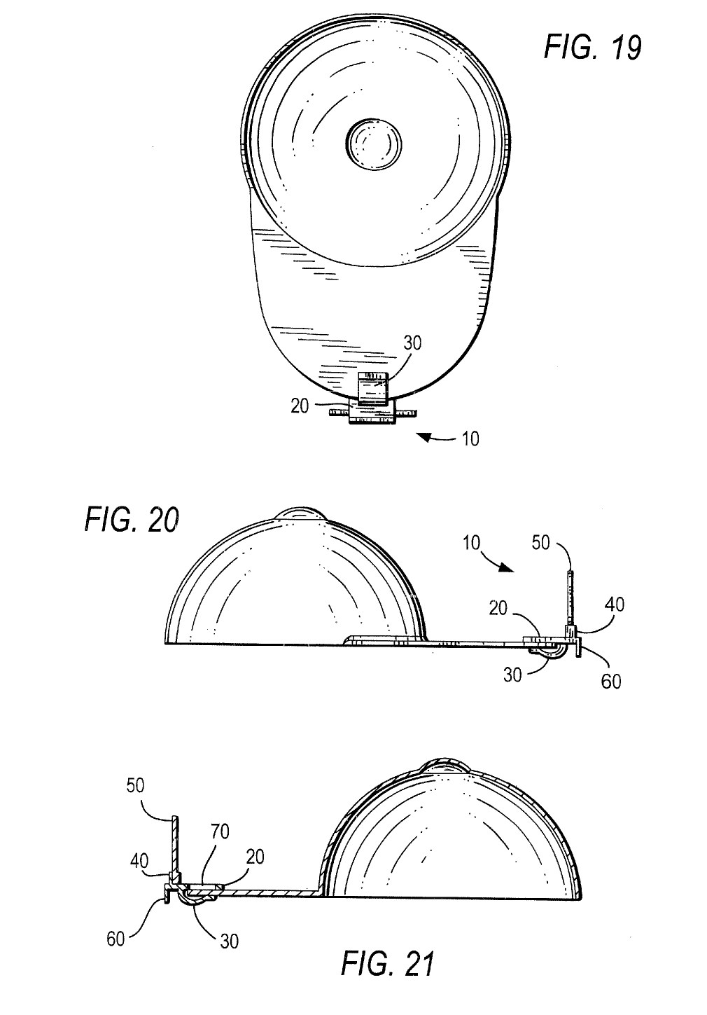

With reference to FIGS. 1-7 and FIG. 23, and as shown in use on a hat in FIGS. 15-22, a preferred embodiment of the hat clip 10 has a base 20 and a clip 30 connected to one side of the base 20 at the bottom surface thereof. The hat clip 10 is preferably flexible and adapted to retain a surface of a hat, such as an outwardly extending brim, between the base 20 and the clip 30. The hat clip 10 is preferably flexible enough to accommodate a wide range of hat brims and the like having varying degrees of thickness. The hat clip 10 is capable of being physically relocated to different locations along a brim or bill without having to be removed or re-clipped.

The hat clip 10 preferably includes a neck 40 connected to the upper surface of the base 20 which supports a top or billboard 50. Alternatively, a clip may be provided on the opposite side of the base 20 at the upper surface thereof in addition to or instead of the clip 30 as depicted in the drawings such that a clip is provided on the same side of the base 20 as the neck 40. The billboard 50 carries the payload of the hat clip, such as actual team logos, advertisements, peace signs, “smiley faces” and/or other markings, decorative grooves and visual indicia that may be provided in or on the billboard area. Visual image areas of the billboard 50 (and panel 60, discussed below) may be decorated with printed stickers, spray painting, engraving, screen printing, pad printing and other methods known in the art. It should also be understood that the billboard 50 may be connected directly to the base 20 without a neck 40. It should further be understood that other types of display elements and devices may be utilized in place of or in addition to the billboard depicted in the drawings. Some examples are provided below.

The hat clip 10 preferably includes a front panel 60 connected at the front side of the base 20 opposite the opening between the base 20 and the clip 30. The front panel 60 primarily serves to balance the weight of the hat clip 10 when it is clipped to a hat, and the front panel 60 likewise allows the hat clip 10 to stand or rest on its own for storage or decorative display when the hat clip 10 is placed on a generally even surface, such as a shelf or a desk. Although the front panel 60 primarily serves to balance the weight of the clip 10, the panel 60 may also comprise markings, decorative grooves and visual indicia on its surface.

The base 20 may include a cutout 70, as most clearly illustrated in FIGS. 4-5, FIG. 7 and FIG. 23, to reduce the overall weight of the hat clip 10 and the amount of material necessary to manufacture it. In addition, the hat clip 10 preferably has no sharp edges in order to prevent injury and damage to the hat, other apparel or objects with which it is utilized. Providing a cutout 70 is also useful in reducing unwanted wear and tear and/or deformation of the hat or material in the location where the hat chip 10 is attached. Likewise, an alternative embodiment of the hat clip 10 with a cutout 70 may provide a portion of the clip 30 (such as the end thereof proceeding through the cutout 70 to create a more firm connection between the hat clip 10 and the brim or other surface to which it is attached.

The billboard 50 of the hat clip 10 may be integrally molded or mounted on the neck 40 of the hat clip 10, so that the billboard 50 is permanently attached to the base 20. The hat clip 10 may be injection molded to achieve that result, or the respective parts may alternatively be attached together by sonic-welding, glue, heat fusion or other suitable methods of manufacture. The hat clip 10 is preferably manufactured from plastic, but any other durable, lightweight materials, and even metals, alloys and combinations of metals and non-metals, may also be used instead of or in addition to plastics.

The top or billboard 50 is preferably permanently attached to the base 10 by a snapping connection. The top 50 can assume a rectangular, square, circular, oval or any other suitable geometric or non-geometric shape. The custom shapes include a shape of a football jersey, a ribbon for charity, an airplane, a three-dimensional figurine or object, or any custom image. The tops 50 could also be manufactured of varying sizes, where the base 20 and other parts of the clip 10 can be correspondingly enlarged to support the top 50. Alternatively, the top 50 may be attached to the base by using bolts, pins, hinges, magnets, sonic welding, or any other attachment means well known in the art. The top may also slide in and out on rails.

In an alternative embodiment, a different type of connection may be provided that allow for a selectively removable connection of the top to the base such that different/multiple tops may be utilized as desired by a user for increased versatility. In this embodiment, the top would be designed to be interchangeable or customized. This is accomplished by having the neck of the hat clip separate approximately in the middle. The top may have a male element and the base a cooperating female element for connecting the parts of the neck. The connection is preferably such that the top is rotatable around the vertical axis of the neck. In this embodiment, the top can display indicia on two sides of the top panel (front and back).

FIG. 24 illustrates a preferred method of attachment of the billboard 50 to the neck 40. The neck 40 has an opening 41 accepting a cooperating element 43 of the billboard 50. The side of the base 20 where the clip 30 is located preferably has a slot 45 between the clip 30 and the front panel 60, and the element 43 preferably has wings 47 received by the slot 45 to secure the billboard 50 to the base 20 by a “snap-in” connection. The element 43 may be rectangular, or it may be cylindrical in its cross-section so as to be able to rotate around its vertical axis, enabling the billboard 50 to be rotated by a user or even by the wind in instances where the connection creates less friction.

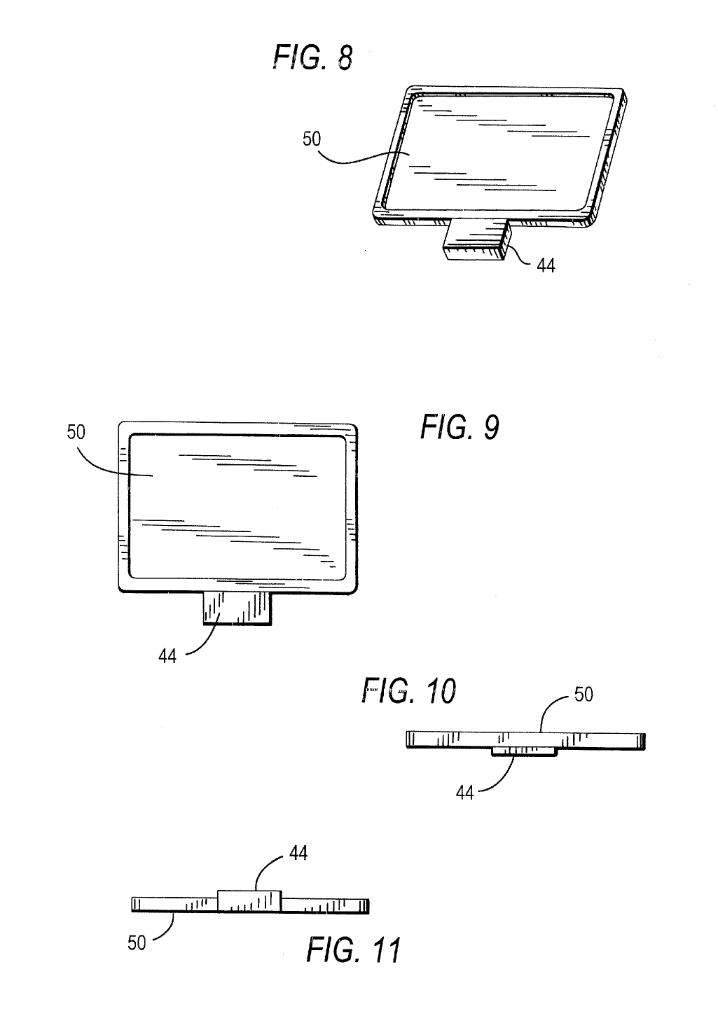

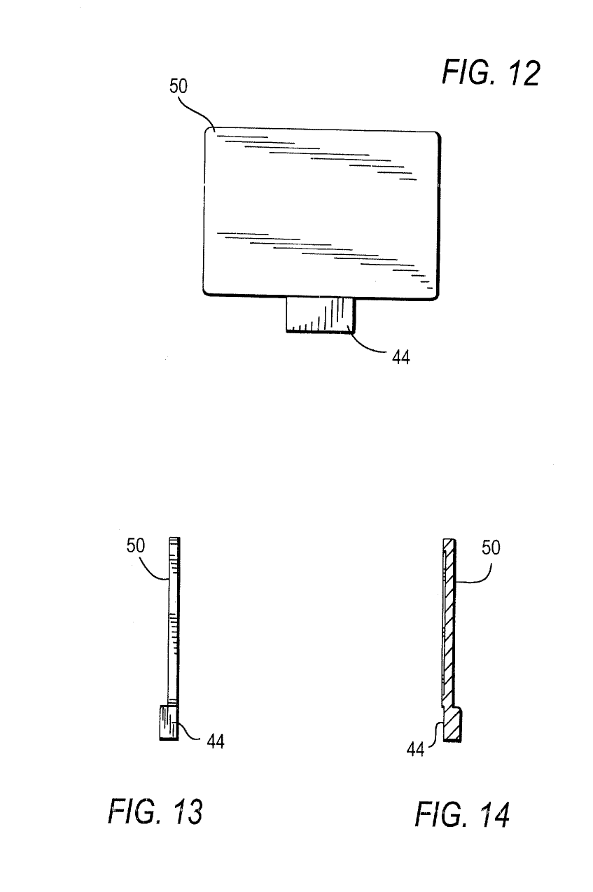

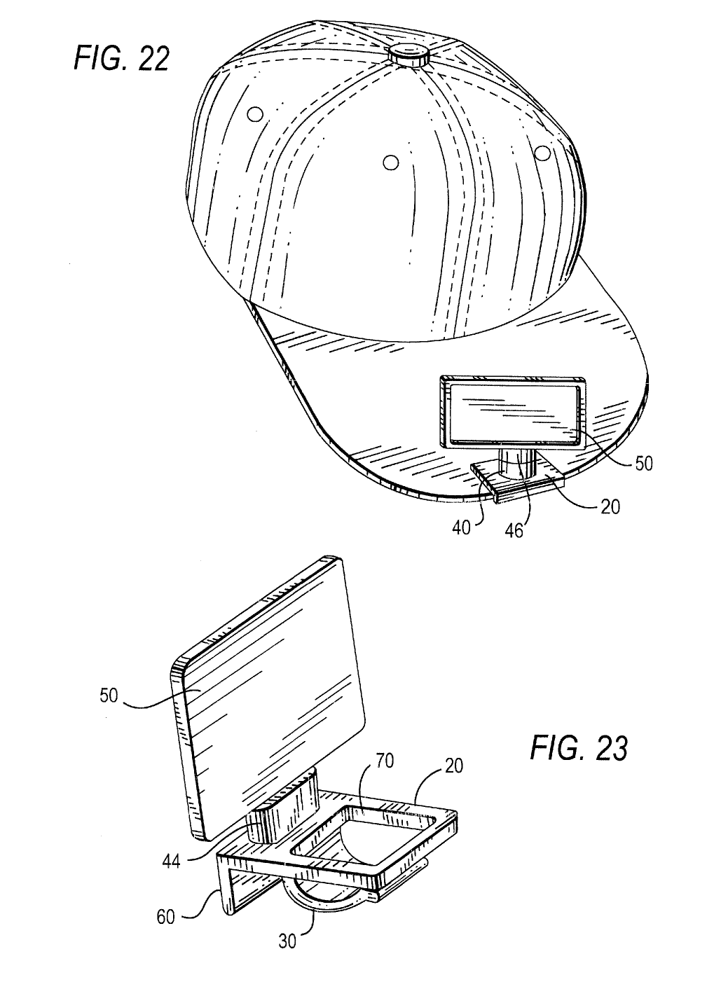

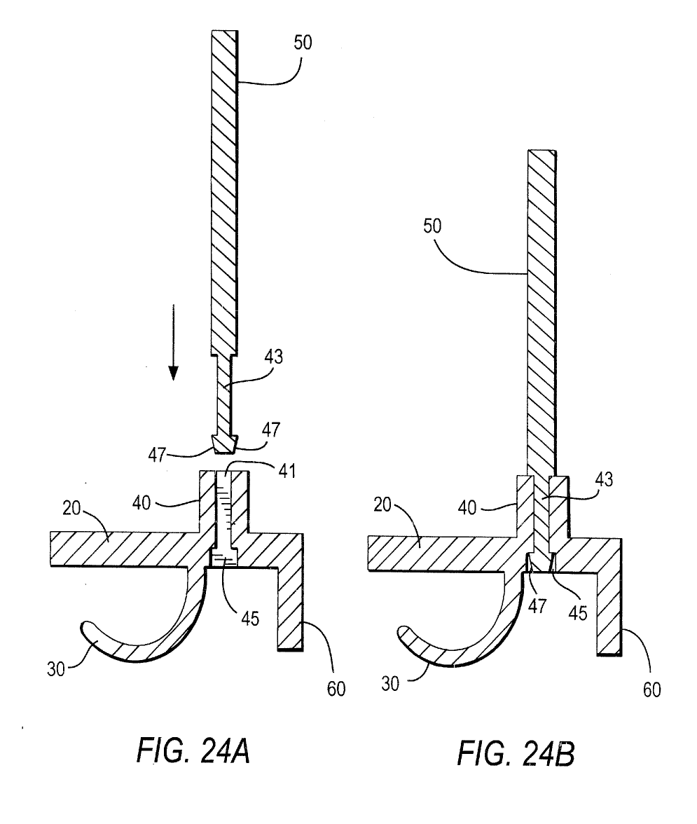

FIG. 7 and FIG. 23 illustrate another possible attachment of the billboard 50 to the neck 40. The neck 40 has a recess 42, cooperating with a protrusion 44, as shown in FIGS. 8-14, extending from the billboard 50. The recess 42 accepts the protrusion 44 to form the neck 40 with a uniform appearance. Alternatively, as illustrated in FIG. 22, the neck 40 positioned on the base 20 may have a receptacle that accepts a cooperating element 46 connected to the billboard 50 so that the billboard 50 is rotatably movable around the vertical axis of the neck 40 and the element 46. An example of such a connection is a plug or a pin connected to or formed with the element 46 and inserted into a cooperating opening in the neck 40.

FIGS. 15-21 illustrate the attachment of the hat clip 10 to a hat and the use of the hat clip 10. The hat clip 10 is typically attached to a hat by positioning the hat cap between the base 20 and the clip 30 of the hat clip 10. The front panel 60 is therefore located in front of the hat cap as shown in FIGS. 15-16. The payload of the top or billboard 50 is then visible to the public. The hat clip 10 may also be attached on the sides of a hat with a bill or brim. In the embodiment of the present invention where a top or billboard 50 is rotatably attached to the base 20, the position of the top or billboard 50 can be adjusted by rotating it left-to-right and right-to-left as shown in FIG. 22. In yet another embodiment of the hat clip 10, the rotatable top 50 may be motorized, preferably actuated by a very small electric motor, thus being capable of rotating with the indicia displayed without user intervention.

Although the invention has been described in terms of particular embodiments, the embodiments are merely illustrative of an application of the principles of the invention. Numerous modifications may be made and other arrangements may be devised without departing from the spirit and scope of the invention. Such alternatives may include modification of the clip such that it may attach to other forms of clothing and consumer products.

1. A clipping device for displaying visual indicia on a hat comprising:
a base having an upper surface and a lower surface;
a clip connected to said base, said clip being oriented to allow said hat to be retained between said clip and said base; and
a billboard for displaying visual indicia, said billboard being connected to said base at said upper surface.

2. The clipping device of claim 1 further comprising a neck, said neck connecting said billboard to said base.

3. The clipping device of claim 2, said billboard being rotatable.

4. The clipping device of claim 3, said device further comprising a motor for rotating said billboard.

5. The clipping device of claim 1, further comprising a front panel for balancing said clipping device.

6. The clipping device of claim 1, said clip being connected to said lower surface of said base.

7. The clipping device of claim 1, said base comprising a cutout.

8. The clipping device of claim 1, further comprising interlocking elements adapted to fit with one another for forming a string of clipping devices.

9. The clipping device of claim 1, said billboard being selectively removable and replaceable with another billboard.

10. A clipping device for displaying visual indicia comprising:
a base having a two surfaces that are positioned opposite one another;
a clip element connected to said base at least one of said surfaces;
a neck section connected to said base at one of said surfaces;
a top display element connected to said base by said neck.

11. The device of claim 10, said top display element comprising visual indicia.

12. The device of claim 10, said top display element being selectively removable from said neck.

13. The device of claim 10, said top display element being rotatable at said neck.

14. The device of claim 10, further comprising a front panel positioned below said top display element for balancing said device.

15. The device of claim 10, further comprising a cutout in said base and at least a portion of said clipping element being disposed within said cutout.

16. A rim supported payload display device to be attached to a head mounted headgear comprising a projecting rim, said rim having an upper surface and a lower surface, comprising:
a base, said base adapted to be positioned on one of said upper surface or said lower surface of said rim;
a clip, said clip attached to said base forming a clipping connection around said rim, and situated on the other of said upper surface or said lower surface of said rim opposite said base; and
a billboard element for display of said payload, said billboard element attached to said base.

17. The display device of claim 16, further comprising a front panel, said front panel attached to said base below said billboard element.

18. The display device of claim 16, further comprising a neck for attaching said billboard element to said base.

19. The display device of claim 17, said billboard element being in rotatable connection with said neck.

20. The display device of claim 17, said billboard element being selectively removable.
